(19) United States
(12) Patent Application Publication
(10) Pub. No.: US 2014/0263736 A1
(43) Pub. Date: Sep. 18, 2014

(54) ORBITAL SPRAY BAR ASSEMBLY FOR SURFACE CLEANING APPARATUS

(71) Applicant: James Crocker, Stuart, FL (US)

(72) Inventor: James Crocker, Stuart, FL (US)

(21) Appl. No.: 14/214,350

(22) Filed: Mar. 14, 2014

Related U.S. Application Data
(60) Provisional application No. 61/801,355, filed on Mar. 15, 2013.

(51) Int. Cl. B05B 3/04

(52) U.S. Cl. CPC B05B 3/0445
USPC 239/263; 239/225.1

(57) ABSTRACT

The present invention relates generally to an environmentally sensitive mobile cleaning system, and more specifically relates to an orbital spray bar head for high or ultra-high pressure mobile cleaning apparatus. The orbital spray bar head works in combination with a mobile pressure cleaning apparatus for cleaning surfaces while minimizing water usage and containing contaminants before they enter a storm water drain system.

### PRIORITY CLAIM

In accordance with 37 C.F.R 1.76, a claim of priority is included in an Application Data Sheet filed concurrently herewith. Accordingly, the present invention claims priority to U.S. Provisional Patent Application No. 61/801,355, entitled, “Orbital Spray Bar Assembly for Surface Cleaning Apparatus”, filed Mar. 15, 2013. The contents of the above referenced application is incorporated herein by reference.

### FIELD OF INVENTION

The present invention generally relates to surface cleaning systems, and more particularly to a spray bar assembly that moves in an orbital pattern and is particularly suited for surface cleaning apparatus.

### BACKGROUND INFORMATION

Surface cleaning apparatus, such as pressure washers, are useful for cleaning a variety of objects. Although there are many types of pressure washing systems, a typical system utilizes an engine that powers a pump. The inlet side of the pump is connected to a low pressure water source such as a tank or a municipal water supply, while the high pressure side of the pump is connected to a high pressure hose and wand for controlling the flow of high pressure water generated by the pump. The high pressure water is directed at a surface to dislodge dirt, paint and the like, and the water is generally allowed to drain into the storm sewer.

Ultra-high pressure washers, supplying more than 25,000 P.S.I. are also known. These systems include a large engine, typically diesel, which operates a large multi-cylinder pump to generate high volumes of water at ultra-high pressures. The ultra-high pressure water is directed through piping and/or hoses to various types of blast heads suitable for controlling the flow and direction of the ultra-high pressure water. One particular use for ultra-high pressure water devices is the removal of stripes or other markings from road surfaces. When polymers such as paint or plastic are used for roadway marking, the surface of the pavement is penetrated from ⅛-⅜ inch; whereby water blasting is the only known method of removing the stripe material from below the surface without removing a portion of the roadway surface. Ultra-high pressure water pressure washers are also utilized for removing paint from ships, cleaning industrial facilities, removing graffiti, removing rubber from aircraft runways and demolition.

One common device utilized with surface cleaning devices is the rotary spinner bar. The rotary spinner bar typically includes a tubular member having a central point at which it is connected to a bearing assembly for rotation thereabout. At least one nozzle is secured on each side of a bearing mount. The nozzles may be inclined to cause rotation of the spinner bar, or alternatively a motor is connected to the spinner bar to cause rotation thereof about the bearing assembly as pressurized water is directed through the bar and thus the nozzles. As the spinner bar rotates, the high pressure water is directed at the surface to dislodge unwanted particles, paint or the like. A shroud may be positioned around the spinner bar to contain the water and debris, and vacuum may be attached to the shroud for removing the water and debris from the shroud for containment.

Several problems are associated with the rotary spinner bars. One such problem relates to the evenness of the cleaned surface. The nature of the rotary spinner bar causes the sides of the surface to be cleaned multiple times during forward motion while the center portion is only cleaned once. This causes stripes that are repeated across the surface being cleaned. Another drawback relates to the speed at which the rotary spinner bar is required to rotate to achieve an acceptable surface. Most spinner bars rotate at speeds of about 3000 revolutions per minute. The high speeds often result in damage to the spinner bar contacting debris or bumps in the surface. Still another drawback is the load on the central bearing which must take the entire load of the spinning bar and resultant forces from the water impinging the surface.

Therefore, there is a need in the art for an orbital spray bar head that is suitable for applications that include low and high pressure or ultra-high pressure water cleaning equipment. The water recirculation system should provide a predetermined amount of clean water to start the cleaning operation. The orbital spray bar head should eliminate the need to rotate the spray bar for cleaning a surface width wider than can be cleaned with a single static nozzle. The orbital spray bar head should be compact enough to fit on a mobile frame that may also contain the high or ultra-high pressure water cleaning equipment.

Thus, the present invention provides an orbital spray bar head for surface cleaning apparatus and the like which overcomes the disadvantages of the prior art systems.

### SUMMARY OF THE INVENTION

The present invention relates generally to an environmentally sensitive mobile cleaning system; and more specifically relates to an orbital spray bar head for high or ultra-high pressure mobile cleaning apparatus. The orbital spray bar head works in combination with a mobile pressure cleaning apparatus for cleaning surfaces while minimizing water usage and containing contaminants before they enter a storm water drain system. An entire cleaning system includes a water tank sized to contain an established volume of fluid sufficient to circulate through the system, a pump to pressure the fluid to the orbital spray bar assembly, a vacuum system to return the contaminated fluid to a tank, and may include a filter means to remove the contaminants from the fluid so that clean fluid can be reintroduced to the orbital spray bar head. The method comprises the steps of increasing the pressure of a fixed volume of fluid, jetting or blasting the surface with the pressurized fluid through the orbital spray bar assembly, vacuuming the blasted fluid into the system, and removing the contaminants from the fluid. The orbital spray bar assembly may include an adjustable oscillation and may be rotatable to vary the width of the surface being cleaned with a single orbital head.

Accordingly, it is an objective of the present invention to provide an environmentally sensitive cleaning system.

It is a further objective of the present invention to provide an orbital spray bar head for a surface cleaning apparatus.

It is yet a further objective of the present invention to provide an orbital spray bar head that includes an adjustable oscillation.

It is another objective of the present invention to provide an orbital spray bar head that includes speed adjustable oscillation.

It is yet another objective of the present invention to provide an orbital spray bar head that may be rotated to vary the width of the surface being cleaned.

It is still yet another objective of the present invention to provide an orbital spray bar assembly that includes removable and replaceable spray nozzles.

Yet another objective of the present invention is to provide an orbital spray bar assembly that includes a fluid powered rotational motor to provide motive force for the oscillation.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 is a top perspective view that illustrates one embodiment of the orbital spray bar head for surface cleaning apparatus of the instant invention;

FIG. 2 is a side view of the orbital spray bar head illustrated in FIG. 1;

FIG. 3 is a top view of the orbital spray bar head illustrated in FIG. 1;

FIG. 4 is a bottom view of the orbital spray bar head illustrated in FIG. 1;

FIG. 5 is a front view of the orbital spray bar assembly illustrated in FIG. 1;

FIG. 6 is an exploded view of the orbital spray bar head illustrated in FIG. 1;

FIG. 7 is a top view of one embodiment of a spray bar for the orbital spray bar head illustrated in FIG. 1;

FIG. 8 is a side view of the spray bar illustrated in FIG. 7;

FIG. 9 is a rear view of the spray bar illustrated in FIG. 7;

FIG. 10 is a section view of the spray bar illustrated in FIG. 7 taken along lines 10-10 of FIG. 8; and

FIG. 11 is an exploded view of the spray bar illustrated in FIG. 7.

### DETAILED DESCRIPTION OF THE PREFERRED EMBODIMENTS

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiments illustrated.

Referring generally to FIGS. 1-11, an orbital spray bar head 100 is illustrated. The orbital spray bar assembly generally includes a spray bar assembly 2, a rotational assembly 4, an offset assembly 6 and a shroud assembly 8. In general, the orbital spray bar head takes pressurized fluid from a source and divides the fluid for delivery through a plurality of nozzles in an orbital pattern for directing the fluid at a surface to be cleaned or demolished.

Referring to FIGS. 7-11, the spray bar assembly generally includes a spray bar 10, nozzles 12, bearings 14, secondary shaft 16, hose connection 18, and stabilizer 20. The spray bar 10 includes an inlet conduit 22 for receiving pressurized fluid from supply hose 23 and routing it in a predetermined pattern to a plurality of nozzles 12 through internal cavity 21. In a preferred embodiment, the spray bar is constructed to surround a central aperture 24 which houses bearings 14. Secured above the bearings are thrust bushings 26 which cooperate with the shroud assembly 8 and rotational assembly 4 to prevent unwanted harmonics and oscillations in the spray bar during orbital movement thereof. The thrust bushings may be constructed of any suitable material including metals, plastics, ceramics or suitable combinations thereof. The secondary shaft 16 includes a first end 28 sized to cooperate with the spray bar bearing 14 and a second end 30 sized to cooperate with the offset assembly 6. Stabilizer 20 is constructed and arranged to surround the inlet conduit 22 and includes sufficient length and stiffness to cooperate with the shroud assembly 8 to prevent rotation of the spray bar within the shroud. In a preferred embodiment, the stabilizer is secured to the spray bar 10 via threads 25. It should be noted that while the stabilizer is illustrated as a tubular member, it may be a rod, cable, spring member or the like without departing from the scope of the invention. In a preferred embodiment, the spray bar is constructed to accept a plurality of nozzles 12 positioned around the central aperture 24. In a most preferred embodiment, the spray bar is constructed to accept about 21 nozzles that are of the sapphire or diamond lined ultrahigh pressure type; however, it should be noted that any number and type of nozzles may be utilized without departing from the scope of the invention. It should also be noted that while it is preferred that the nozzles are arranged around the central aperture to distribute loading, the nozzles may be positioned on one or more sides of the central aperture without departing from the scope of the invention. Blast shield 32 and rubber liner 34 are preferably positioned around the spray bar 10 to protect the spray bar from debris being dislodged from the surface being cleaned. In a preferred embodiment, the blast shield 32 is constructed from a durable material such as stainless steel; however, other materials may be utilized without departing from the scope of the invention. It should also be noted that the spray bar 10 includes a width that is greater than its depth. This construction allows the spray bar to be rotated to alter the width of the surface being cleaned.

Referring to FIGS. 1-6, the rotational assembly 4, offset assembly 6 and shroud assembly 8 are illustrated. In a preferred embodiment, the rotational assembly 4 is a fluid drive motor 40 having a fluid inlet 42 and a fluid outlet 44 for causing rotation of an output shaft (not shown). The output shaft is sized to fit into a first aperture 46 of the offset assembly 6. The fluid drive motor 40 is preferably a positive displacement type hydraulic motor, and should provide sufficient rotational torque to spin the offset assembly and the attached spray bar assembly. It should also be noted that other means of rotating the offset assembly may be utilized without departing from the scope of the invention; such means may include, but should not be limited to, pneumatic motors, cable drives, gear drives and the like. The offset assembly generally includes a main plate 48 having a first aperture 46 sized to cooperate with the rotational assembly output shaft and a second aperture 50 sized to cooperate with the second end 30 of the secondary shaft 16 and a counterweight 52. The distance between the first and second apertures 46, 50 controls the orbital travel of the spray bar assembly 10. In at least one embodiment (not shown) the distance between the first and the second apertures is adjustable to allow the orbital path to be varied. The counterweight 52 is sized to substantially equal the weight of the spray bar assembly to minimize the vibration caused from oscillating the spray bar assembly 10. Plate 54 is preferably positioned between the spray bar and the offset assembly 6 to reduce or prevent debris from being deflected into the rotating path of the offset assembly.

Still referring to FIGS. 1-6, the shroud assembly 8 is generally constructed and arranged to contain fluid and deflected debris. The shroud assembly includes a top wall 58 and a side wall 60, and in some embodiments a brush 62 surrounds the side wall to help retain spray mist and the like. In some embodiments, the side wall 60 of the shroud has a predetermined height to maintain the spray bar a predetermined distance from the surface being cleaned. The side wall of the shroud assembly is also utilized to cooperate with the stabilizer 20 to prevent rotation of the spray bar. In a preferred embodiment, the shroud assembly 8 includes a vacuum port 56 for connection to a source of vacuum. In this embodiment, a substantial portion of the water and debris may be collected into a tank for recycle or disposal.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An orbital spray bar head apparatus comprising:
a spray bar assembly, said spray bar assembly including an inlet conduit for receiving pressurized fluid to an internal chamber, a plurality of nozzles secured to said spray bar and arranged in a predetermined pattern, each of said nozzles in fluid communication with said inner chamber,
an offset assembly, said offset assembly secured between said spray bar assembly and a rotational assembly, said offset assembly including an axis of rotation about which said offset assembly is rotated by said rotational assembly, said spray bar assembly secured to said offset assembly a predetermined distance from said axis of rotation, said rotational assembly having sufficient rotational torque to spin said offset assembly and said attached spray bar assembly, and
a shroud assembly, said shroud assembly constructed and arranged to support said rotational assembly in a fixed position with respect to said offset assembly and said spray bar assembly.

2. The orbital spray bar apparatus of claim 1 wherein said spray bar assembly includes a central aperture, said central aperture not in fluid communication with said internal chamber, said central chamber including at least one bearing, said at least one bearing having a central aperture, a secondary shaft having a first end sized to cooperate with said central aperture in said at least one bearing, a second end of said secondary shaft constructed and arranged to cooperate with said offset assembly for securement thereto.

3. The orbital spray bar apparatus of claim 2 wherein said secondary shaft includes a thrust bearing thereabout, said thrust bearing constructed and arranged to engage said offset assembly and said spray head during rotation of said offset assembly.

4. The orbital spray bar apparatus of claim 2 including a stabilizer, said stabilizer being secured to said shroud and constructed and arranged to surround said inlet conduit to prevent rotation of said spray bar assembly within said shroud while allowing said orbital movement.

5. The orbital spray bar apparatus of claim 1 wherein said plurality of nozzles are ultra-high pressure type nozzles for waterblasting.

6. The orbital spray bar apparatus of claim 5 wherein said plurality of nozzles are lined with sapphire.

7. The orbital spray bar apparatus of claim 1 wherein said spray bar assembly includes a blast shield positioned to surround said spray bar assembly for protecting said spray bar assembly from debris dislodged from a surface being cleaned.

8. The orbital spray bar apparatus of claim 7 including a rubber liner positioned between said blast shield and said spray bar assembly.

9. The orbital spray bar apparatus of claim 1 wherein said spray bar assembly includes a width that is greater than its depth, whereby said spray bar can be rotated to alter the width of the surface being cleaned.

10. The orbital spray bar apparatus of claim 1 wherein said rotational assembly is a fluid drive motor having a fluid inlet and a fluid outlet for causing rotation of an output member.

11. The orbital spray bar apparatus of claim 10 wherein said output is a shaft, said output shaft sized to cooperate with an aperture positioned along said axis of rotation of said offset assembly.

12. The orbital spray bar apparatus of claim 10 wherein said fluid drive motor is a positive displacement type hydraulic motor.

13. The orbital spray bar apparatus of claim 11 wherein said offset assembly generally includes a main plate having a first aperture sized to cooperate with the rotational assembly output shaft and a second aperture sized to cooperate with said second end of said secondary shaft and a counterweight sized to compensate for the offset weight of said spray bar assembly.

14. The orbital spray bar apparatus of claim 1 wherein said shroud assembly is constructed and arranged to substantially contain fluid expelled from said plurality of nozzles.

15. The orbital spray bar apparatus of claim 14 wherein said shroud assembly includes a top wall and a side wall.

16. The orbital spray bar apparatus of claim 15 wherein said side wall of the shroud has a predetermined height to maintain the spray bar a predetermined distance from a surface being cleaned.

17. The orbital spray bar apparatus of claim 14 wherein said shroud assembly includes a vacuum port 56 for connection to a source of vacuum.
